(19) United States
(12) Patent Application Publication
(10) Pub. No.: US 2014/0170949 A1
(43) Pub. Date: Jun. 19, 2014

(54) METHOD AND APPARATUS FOR CHECKING TEMPERATURE IN A CLOSED TRAILER

(71) Applicant: PANTHER II TRANSPORTATION, INC., Seville, OH (US)

(72) Inventor: John T. Dwiggins, Medina, OH (US)

(73) Assignee: PANTHER II TRANSPORTATION, INC., Seville, OH (US)

(21) Appl. No.: 13/795,738

(22) Filed: Mar. 12, 2013

Related U.S. Application Data
(60) Provisional application No. 61/737,242, filed on Dec. 14, 2012.

(51) Int. Cl. B60H 1/00

(52) U.S. Cl. CPC B60H 1/00585
USPC 454/75; 165/288

(57) ABSTRACT

A temperature control and tracking system for cargo containers includes temperature probes which are positioned to provide improved temperature tracking of cargo during shipment.

### CROSS REFERENCE TO RELATED APPLICATION

This application claims priority from U.S. Provisional Application Ser. No. 61/737,242 filed Dec. 14, 2012; the disclosure of which is incorporated herein by reference.

### BACKGROUND OF THE INVENTION

1. Technical Field

The present invention relates generally to mobile temperature control systems used for controlling the temperature of cargo during transport thereof. More particularly, the invention relates to such a system having a transportation cargo container with temperature probes positioned to provide improved tracking of temperature readings.

2. Background Information

In the shipping of many goods, controlling the temperature thereof during transit is an important factor. Many temperature control units (TCUs) have been devised to this end, including those which are carried by trucks, boats and aircraft. Temperature probes are used within TCUs both to provide feedback for controlling the temperature and to provide temperature readings which may be tracked throughout the duration of the transportation of the cargo within the TCU. However, the use of such temperature probes has provided localized temperature readings and/or temperature readings which do not provide an accurate indication of the temperature especially in certain areas of a cargo container. The present invention addresses this problem in the art.

### BRIEF SUMMARY OF THE INVENTION

The present invention provides a temperature monitoring system comprising a transportation cargo container comprising a bottom wall, a top wall, a front wall, a back wall, a left side wall and a right side wall wherein the walls define an interior cargo chamber; a temperature control unit (TCU) for controlling temperature within the cargo chamber; a first temperature probe within the cargo chamber; a second temperature probe within the cargo chamber rearward of the first probe; and a third temperature probe within the cargo chamber rearward of the second probe.

The present invention also provides a temperature monitoring system comprising a transportation cargo container comprising a bottom wall, a top wall, a front wall, a back wall, a left side wall and a right side wall wherein the walls define an interior cargo chamber; a temperature control unit (TCU) for controlling temperature within the cargo chamber; a first temperature probe mounted on one of the left and right side walls; a second temperature probe mounted on one of the left and right side walls rearward of the first probe by a distance of at least two feet; and a third temperature probe mounted on one of the left and right side walls rearward of the second probe by a distance of at least two feet.

The present invention further provides a temperature monitoring system comprising a transportation cargo container comprising a bottom wall, a top wall, a front wall, a back wall, a left side wall and a right side wall wherein the walls define an interior cargo chamber; a temperature control unit (TCU) for controlling temperature within the cargo chamber; and first, second and third temperature probes within the cargo chamber wherein one of the probes is mounted on the top wall.

### BRIEF DESCRIPTION OF THE SEVERAL VIEWS OF THE DRAWINGS

FIG. 1 is a side elevation view of the temperature control system of the present invention.

FIG. 2 is an enlarged top plan view showing the cargo container of the temperature control system.

FIG. 3 is a side elevation view showing the cargo container.

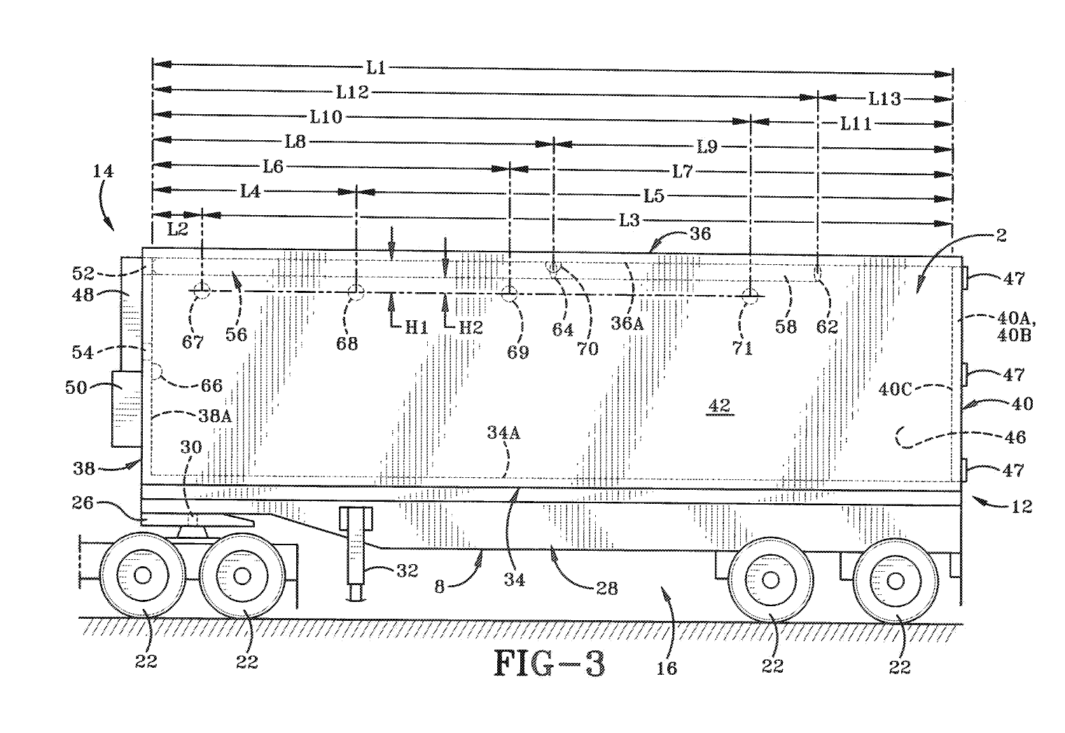

A preferred embodiment of the invention, illustrated of the best mode in which Applicant contemplates applying the principles, is set forth in the following description and is shown in the drawings and is particularly and distinctly pointed out and set forth in the appended claims.

Similar numbers refer to similar parts throughout the drawings.

### DETAILED DESCRIPTION OF THE INVENTION

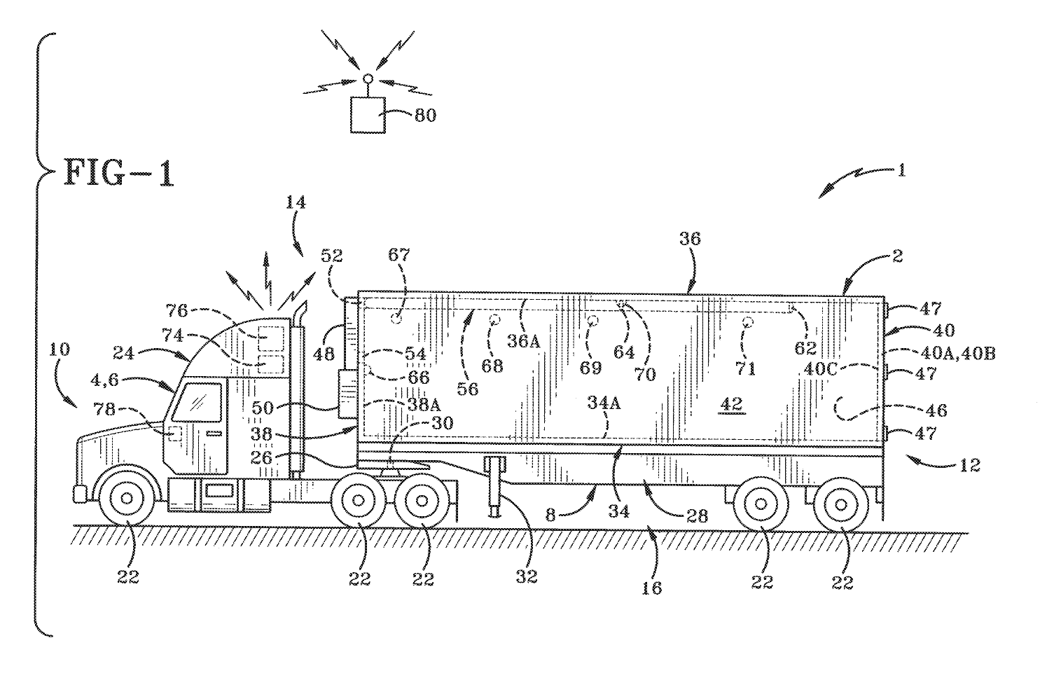

The temperature control system of the present invention is shown generally at 1 in FIG. 1 and includes a transportation cargo body or container 2 configured to contain cargo which is to be maintained within a desired temperature range. Container 2 is shown as being part of or carried by a tractor trailer vehicle 4 although container 2 may be carried on other types of vehicles or may be a standalone container as discussed further below. Vehicle 4 includes a towing vehicle in the form of an over-the-road tractor 6, and a towed vehicle or trailer 8 which is towed by tractor 6. Vehicle 4 has a front and back 10 and 12 defining therebetween a longitudinal direction, a top 14, a bottom 16, and left and right sides 18 and 20 defining therebetween an axial direction. Tractor 6 includes a chassis or frame with ground engaging wheels 22 rotatably mounted thereon, an engine for driving the rotation of wheels 22, a cab 24 in which the driver and/or passengers may sit, and a hitch member 26 shown here in the form of a fifth wheel for hitching trailer 8 to tractor 6 so that trailer 8 is pivotable at the hitch about a vertical axis. Trailer 8 includes a rigid frame 28 with ground engaging wheels 22 rotatably mounted thereon adjacent back 12, a hitch member 30 which hitches to hitch member 26, and landing gear rearward of hitch member 30 and generally adjacent the front of the trailer. Landing gear 32 is configured to contact the ground to support the front end of the trailer when it is unhitched from tractor 6.

Container 2 includes a bottom wall 34, a top wall 36, a front wall 38, a back wall 40, a left side wall 42 and a right side wall 44 wherein the walls define therewithin a cargo storage chamber 46. Container 2 is secured along bottom wall 34 to the top of frame 28. Container 2 may be permanently secured to the trailer frame 28 or removably mounted thereon such that container 2 may be separated from the trailer frame. In the exemplary embodiment, bottom and top walls 34 and 36 are substantially flat and horizontal and rectangular as viewed from above. Front and back walls 38 and 40 are in the exemplary embodiment substantially flat, vertical and parallel to one another and lie along respective vertical planes which extend in the axial direction. Left and right side walls 42 and 44 in the exemplary embodiment are flat, rectangular, parallel to one another, vertical and lie along respective vertical planes which extend in the longitudinal direction. Thus, container 2 typically is in the form of a box shape or parallelepiped configuration although this may vary to some degree. Likewise, chamber 46 typically has a box shape or a parallelepiped configuration defined by the interior surfaces of the various walls of container 2. Back wall 40 is largely made up of left and right doors 40A and 40B which are respectively pivotally mounted on hinges 47 adjacent the back of left side wall 42 and the back of right side wall 44 whereby doors 40A and 40B are movable pivotally between opened and closed positions. Bottom floor 34 has a top inner surface 34A, top wall 36 has a bottom inner surface 36A, front wall 38 has a rear inner surface 38A, back wall 40 has a front inner surface 40C, left side wall 42 has a right inner surface 42A, and right side wall 44 has a left inner surface 44A.

System 1 further includes a temperature control unit 48 or TCU typically mounted on the front wall 38 of container 2 and configured for controlling the temperature of the air and cargo within chamber 46. TCU 48 typically includes a refrigeration unit and also may include a heating unit in order to respectively cool or heat the air within chamber 46, and thus also the cargo therein. System 1 further includes a fuel tank 50 for containing fuel to power the motor of TCU 48 whereby TCU 48 is capable of running for multiple days on its own without a need for any connection to the power system of tractor 6 or other external power sources. TCU 48 and fuel tank 50 are shown diagrammatically. Fuel tank 50 is shown mounted on the front of front wall 38 although tank 50 may be mounted in other locations such as beneath the container on trailer frame 28 and so forth. TCU 48 includes an air outlet 52 which is typically adjacent the top of front wall 38 and adjacent the front of top wall 36. Air outlet 52 is an opening formed through the front wall 38. TCU 48 further includes an air inlet or air return inlet 54 typically below outlet 52 whereby TCU 48 receives return air from within chamber 46. An air duct 56 is provided for channeling airflow from air outlet 52 rearwardly within chamber 46. Air duct 56 includes a front section which communicates with outlet 52 and extends axially therefrom, a longer chute 58 which extends along the top of left side wall 42 and the left side of top wall 36, and a shorter chute 60 which extends along the top of right side wall 44 and along the right side of top wall 36. Longer chute 58 is substantially straight, longitudinally elongated, horizontal and has an air discharge outlet 62 at its rear end. Similarly, shorter chute 60 is substantially straight, longitudinally elongated, horizontal and has a rear air discharge outlet 64 at its rear end. Thus, chutes 58 and 60 are substantially parallel to one another although longer chute 58 is substantially longer than chute 60 such that outlet 62 is substantially rearward of outlet 64.

In accordance with a main feature of the invention, system 1 includes a variety of temperature probes or temperature sensors which are positioned to take temperature readings at various locations within interior chamber 46. More particularly, these temperature probes include a first temperature probe 66 which is mounted on front wall 38 adjacent air return inlet 54, a second temperature probe 67 which is mounted on left side wall 42 rearward of first probe 66, a third temperature probe 68 mounted on left side wall 42 rearward of probe 67, a fourth temperature probe 69 mounted on left side wall 42 rearward of probe 68, a fifth temperature probe 70 which is mounted on top wall 36 rearward of probe 69, and a sixth temperature probe 71 mounted on left side wall 42 rearward of probe 70. Each of temperature probes 66-71 are in electrical or other communication with TCU 48 and also with a data memory 74 and/or a wireless communications unit 76 each of which is typically mounted on tractor 6. A temperature control panel 78 is typically provided within the cab of the tractor and in electrical or other communication with TCU 48 in order to set and control TCU 48 for setting and controlling the temperature within chamber 46. In the exemplary embodiment, communications unit 76 includes a transmitter for wirelessly transmitting signals to be received by a remote receiver 80 which may include a display such as a computer monitor or the like. Typically, receiver 80 may include one or more satellites which also include transmitters for transmitting the signal to the display via the Internet or any other suitable communication pathway.

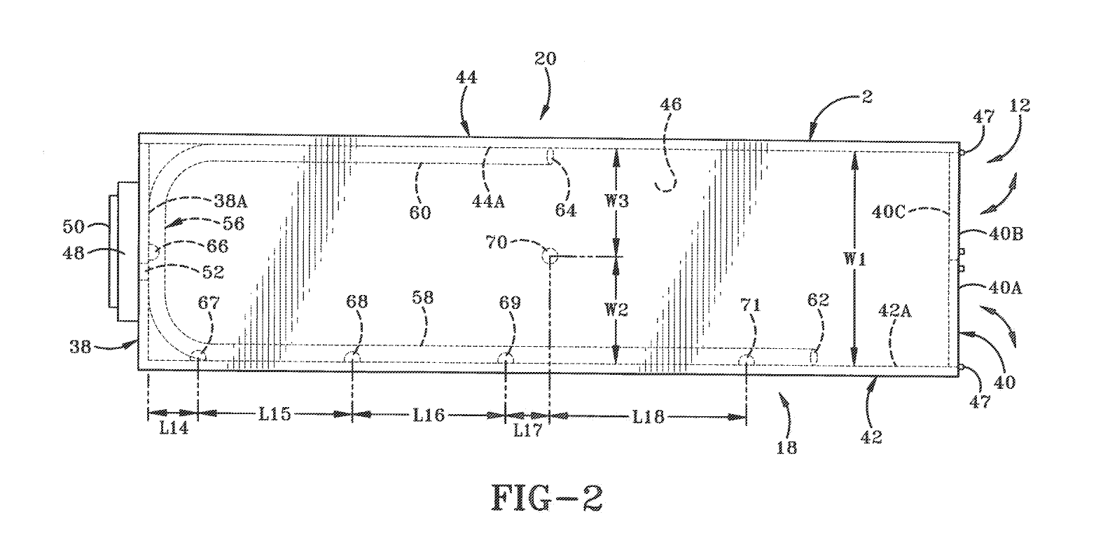

The location of the various temperature probes is now described in greater detail. Container 2 or interior chamber 46 has a length L1 defined between inner surfaces 38A and 40C. Length L1 and other lengths which are denoted herein with an L are horizontal longitudinal lengths, that is, as measured horizontally in the longitudinal direction of the container or vehicle. Temperature probe 66 is mounted on or adjacent front wall 38 typically substantially flush with inner surface 38A and usually not more than about one or two inches rearward thereof. Temperature probe 67 and inner surface 38A define therebetween a length L2; probe 67 and inner surface 40C define therebetween a length L3; probe 68 and inner surface 38A define therebetween a length L4; probe 68 and inner surface 40C define therebetween a length L5; probe 69 and inner surface 38A define therebetween a length L6; probe 69 and inner surface 40C define therebetween a length L7; probe 70 and inner surface 38A define therebetween a length L8; probe 70 and inner surface 40C define therebetween a length L9; probe 71 and inner surface 38A define therebetween a length L10; probe 71 and inner surface 40C define therebetween a length L11; discharge outlet 62 of longer chute 58 and inner surface 38A define therebetween a length L12; and outlet 62 and inner surface 40C define therebetween a length L13. Inner surface 38A and outlet 64 of shorter chute 60 define therebetween a length which is substantially the same as length L8 although this may vary. Probe 67 and inner surface 38A define therebetween a length L14. Probes 67 and 68 define therebetween a length L15. Probes 68 and 69 define therebetween a length L16. Probes 69 and 70 define therebetween a length L17. Probes 70 and 71 define therebetween a length L18. Probe 70 is mounted on top wall 36 and is typically flush with inner surface 36A and typically no lower than one or two inches below inner surface 36A. In the exemplary embodiment, each of the side wall temperature probes 67, 68, 69 and 71 are at approximately the same height. Thus, bottom surface 36A and each of said probes 67, 68, 69 and 71 define therebetween a vertical distance or height H1; and each of probes 67, 68, 69 and 71 and surface 36A define therebetween a vertical distance or height H2. As shown in FIG. 2, inner surfaces 42A and 44A define therebetween a width W1 of interior chamber 46; probe 70 and surface 42A define therebetween a width W2; and probe 70 and inner surface 44A define therebetween a width W3. In the exemplary embodiment, width W2 is typically equal or substantially equal to width W3. Each of widths W1, W2 and W3 are more particularly horizontal axial widths or distances, that is, as measured horizontally in the axial direction of the container or vehicle, and thus perpendicular to the measurement of the longitudinal lengths discussed previously.

As previously discussed, the temperature control system of the present invention is shown with container 2 mounted on a trailer frame of a tractor trailer vehicle such that the trailer is towed by the tractor and is pivotable relative to the tractor about a vertical axis. However, the Figures are also intended to represent the use of the temperature control system including container 12 as the container of a straight truck, which is also commonly known as a box truck, cube truck, bob truck, cube van or box van. Unlike the tractor trailer configuration, the container of the straight truck is rigidly secured to the frame or chassis of the vehicle whereby the straight truck does not have the tractor and trailer configuration in which the trailer is pivotable relative to the tractor. In addition, the present invention includes the concept of a standalone container with the TCU 48 and fuel tank 50 mounted thereon whereby this standalone unit may be removably mounted on trucks, boats or aircraft.

In one embodiment which includes the tractor trailer configuration (and/or the standalone unit), the external length of container 2 is frequently about 53 feet and generally within the range of about 45 to 57 or 59 feet. Especially where container 2 is removable from the trailer frame to provide a standalone unit of container 2, TCU 48 and tank 50, the external length may also be 40 feet or less. The specific lengths, widths and heights illustrated in the Figures and given in this paragraph correspond to a 53 foot container although the various distances may also apply to a container in the range of about 40 or 45 to 59 feet or other containers as well. For a 53-foot container 2, the interior length L1 is typically several inches less than 53 feet and varies depending on the thickness of the front and back walls, which are insulated like the other walls of container 2. Typically, each of the walls of container 2 comprises an inner panel, a layer of insulation and an outer panel whereby the insulation is sandwiched between the inner and outer panels. It will be appreciated by one skilled in art that there are a variety of insulated walls which can be used for the walls of container 2. The lengths provided herein have been rounded off to the nearest foot whereby the actual lengths are typically plus or minus six inches from the values given. Length L1 in the exemplary embodiment is about 53 feet and more broadly within the range of about 40 or 45 to 57 or 59 feet. Length L2 is about 3 feet and more broadly within the ranges of about 2 to 4 feet or 1 to 5 feet. Length L3 is about 50 feet and generally within the ranges of 49 to 51 feet or 47 to 53 feet. Length L4 is about 15 feet and typically within the ranges of 13 to 17 feet or 10 to 20 feet. Length L5 is about 38 feet and within the ranges of 36 to 40 feet or 33 to 43 feet. Length L6 is about 25 feet and within the ranges of 23 to 27 feet or 20 to 30 feet. Length L7 is about 28 feet and within the ranges of 26 to 30 feet or 23 to 33 feet. Length L8 is about 26.5 feet and within the ranges of about 23 to 30 feet or 20 to 33 feet. Length L9 is typically about the same as length L8 and within the same ranges. Length L10 is about 40 feet and within the ranges of 37 to 43 feet or 34 to 46 feet. Length L11 is about 13 feet and within the ranges of 10 to 16 feet or 7 to 19 feet. Length L12 is about 45 feet and within the ranges of about 42 to 48 feet or 39 to 51 feet. Length L13 is about 8 feet and typically within the range of about 5 to 13 feet or 2 to 16 feet. Length L14 is about the same as length L2 given above. Length L15 is about 12 feet and within the ranges of about 10 to 14 feet or 8 to 16 feet. Length L16 is about 10 feet and within the ranges of about 8 to 12 feet or 6 to 14 feet. Length L17 is about 1.5 feet and typically within the range of 0 to 3 feet or 0 to 6 feet. Length L18 is about 13.5 feet and usually within the ranges of 11 to 16 feet or 9 to 18 feet. It is noted that the various lengths between the probes may be determined by adding the lengths given. For example, the longitudinal distance between probes 67 and 69 equals length L15 plus length L16. Likewise, the distance between probe 69 and probe 71 equals length L17 plus length L18. In the exemplary embodiment, each of probes 66-71 are forward of discharge outlet 62. Probes 66-69 are forward of discharge outlet 64, while probe 70 is at about the same longitudinal position as outlet 64, and probe 71 is rearward of outlet 64. Height H1 is about 13 inches and typically within the range of about 11 to 15 inches or 10 to 18 inches. Height H2 is usually about 5 to 6 inches and typically within the range of about 3 to 9 inches. Thus, each of probes 67, 68, 69 and 71 are spaced downwardly from and generally adjacent the bottom of longer chute 58.

For the most part, the maximum width of container 2 is typically about 102 inches, in keeping with the maximum width allowable for commercial motor vehicles on the national network of highways within the United States. Generally in keeping with this width, width W1 as shown in FIG. 2 is typically within the range of about 90 to 98 inches although this may vary somewhat. In the exemplary embodiment, probe 70 is about midway between the front and back walls and also midway between the left and right side walls of container 2 whereby width W2 is typically about the same as width W3. In the exemplary embodiment, width W2 and width W3 are each typically about one-half width W1, and thus usually within the range of about 45 to 49 inches. However, a key aspect of the use of temperature probe 70 is the fact that it is mounted on top wall 36 flush with or generally adjacent to inner surface 36A. More broadly, width W2 and width W3 are typically in the range of 1 or 2 feet to 3 or 4 feet.

In a second embodiment which includes the straight truck configuration or standalone unit noted above, the external length of container 2 is frequently about 20 feet and generally within the range of about 19 to 21. The specific lengths, widths and heights illustrated in the Figures and given in this paragraph correspond to a 20-foot container although the various distances may also apply to a container in the range of about 16 or 18 to 22 or 24 feet or other container lengths as well. For a 20-foot container 2, the interior length L1 is typically several inches less than 20 feet and varies depending on the thickness of the front and back walls, due to the insulated configuration discussed above. Length L1 in the exemplary embodiment is about 20 feet and more broadly within the ranges of about 18 to 22 or 24 feet. Length L2 is about 3 feet and more broadly within the ranges of about 2 to 4 feet or 1 to 5 feet. Length L3 is about 17 feet and generally within the ranges of 16 to 18 feet or 15 to 19 feet. Length L4 is about 7 feet and typically within the ranges of 6 to 8 feet or 5 to 9 feet. Length L5 is about 13 feet and within the ranges of 12 to 14 feet or 11 to 15 feet. Length L6 is about 11 feet and within the ranges of 10 to 12 feet or 9 to 13 feet. Length L7 is about 9 feet and within the ranges of 8 to 10 feet or 7 to 11 feet. Length L8 is about 10 feet and within the ranges of about 9 to 11 feet or 8 to 12 feet. Length L9 is typically about the same as length L8 and within the same ranges. Length L10 is about 15 feet and within the ranges of 14 to 16 feet or 13 to 17 feet. Length L11 is about 5 feet and within the ranges of 4 to 6 feet or 3 to 7 feet. Inasmuch as a straight truck or container of this size typically does not include air ducts, thus there is no corresponding length L12 or length L13, Length L14 (FIG. 2) is about the same as length L2 given above. Length L15 is about 4 feet and within the ranges of about 3 to 5 feet or 2 to 6 feet. Length L16 is about 4 feet and within the ranges of about 3 to 5 feet or 2 to 6 feet. Length L17 is about 1 foot and typically within the range of 0 to 2 feet or 0 to 4 feet. Length L18 is about 5 feet and usually within the ranges of 4 to 6 feet or 3 to 7 feet. It is noted that the various lengths between the probes may be determined by adding the lengths given. For example, the longitudinal distance between probe 67 and 69 equals length L15 plus length L16. Likewise, the distance between probe 69 and probe 71 equals length L17 plus length L18. Height H1 is about 13 inches and typically within the range of about 11 to 15 inches or 10 to 18 inches.

In operation, TCU is operated to control the temperature of air and cargo within chamber 46 within a desired range, as set via control panel 78 or another control panel which may be mounted on TCU 48, container 2, the trailer frame or elsewhere. Probes 66-71 sense the temperature at their respective locations and send signals to TCU 48, memory 74 and/or communication unit 76 indicative of the corresponding temperatures. TCU 48 uses these temperature readings as feedback for automatically controlling the temperature in chamber 46 within a desired temperature range. The temperature reading signals are also recorded or stored in memory 74 whereby they can be subsequently accessed, and are also transmitted by the transmitter of unit 76 to remote location 80 via satellites and/or other transmission pathways so that the temperature readings may be accessed and/or viewed at the remote display. This allows people interested in tracking the temperature of the cargo in chamber 46 to access the temperature readings at the remote display as desired.

More particularly, system 1 allows for tracking the temperatures at the locations of the various probes 66-71, which are positioned to provide a better overall perspective of the temperatures throughout chamber 46. Other systems tend to provide temperature readings which do not give a true idea of “worst case scenarios”. System 1, on the other hand, provides temperature readings at locations which are longitudinally spaced along container 2 as well as a temperature reading adjacent the top wall where the temperature will tend to be higher both as a result of heat rising and from sunlight on top wall 36.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A temperature monitoring system comprising:
a transportation cargo container comprising a bottom wall, a top wall, a front wall, a back wall, a left side wall and a right side wall wherein the walls define an interior cargo chamber;
a temperature control unit (TCU) for controlling temperature within the cargo chamber;
a first temperature probe within the cargo chamber;
a second temperature probe within the cargo chamber rearward of the first probe; and
a third temperature probe within the cargo chamber rearward of the second probe.

2. The system of claim 1 wherein the second temperature probe is rearward of the first probe by a distance in a range of 8 to 16 feet.

3. The system of claim 2 wherein the third temperature probe is rearward of the second probe by a distance in a range of 6 to 14 feet.

4. The system of claim 1 wherein the second temperature probe is rearward of the first probe by a distance in a range of 6 to 14 feet.

5. The system of claim 1 further comprising a fourth temperature probe within the cargo chamber rearward of the third probe.

6. The system of claim 5 further comprising a fifth temperature probe within the cargo chamber rearward of the fourth probe.

7. The system of claim 5 wherein the second temperature probe is rearward of the first probe by a distance in a range of 8 to 16 feet; the third temperature probe is rearward of the second probe by a distance in a range of 6 to 14 feet; and the fourth temperature probe is rearward of the third probe by a distance in a range of 11 to 19 feet.

8. The system of claim 1 wherein one of the probes is mounted on the top wall.

9. The system of claim 1 wherein the second probe is at least 2 feet rearward of the first probe.

10. The system of claim 9 wherein the second probe is at least 4 feet rearward of the first probe.

11. The system of claim 10 wherein the second probe is at least 8 feet rearward of the first probe.

12. The system of claim 11 wherein the third probe is at least 8 feet rearward of the second probe.

13. The system of claim 9 wherein the third probe is at least 2 feet rearward of the second probe.

14. The system of claim 1 wherein the third probe serves as a rearmost temperature sensing probe of the temperature monitoring system and is at least 3 feet forward of the back wall.

15. The system of claim 1 further comprising an air return inlet of the TCU adjacent the front wall; wherein the first probe is adjacent the air return inlet.

16. The system of claim 1 further comprising an air chute which extends rearwardly from the TCU and has a rear air discharge outlet whereby the air chute is configured to direct air from the TCU rearwardly for discharge via the discharge outlet; wherein the first and second probes are forward of the rear air discharge outlet.

17. The system of claim 16 wherein the third probe is forward of the rear air discharge outlet.

18. The system of claim 16 wherein the rear air discharge outlet is at least 20 feet rearward of the front wall.

19. A temperature monitoring system comprising:
a transportation cargo container comprising a bottom wall, a top wall, a front wall, a back wall, a left side wall and a right side wall wherein the walls define an interior cargo chamber;
a temperature control unit (TCU) for controlling temperature within the cargo chamber;
a first temperature probe mounted on one of the left and right side walls;
a second temperature probe mounted on one of the left and right side walls rearward of the first probe by a distance of at least two feet; and
a third temperature probe mounted on one of the left and right side walls rearward of the second probe by a distance of at least two feet.

20. A temperature monitoring system comprising:
a transportation cargo container comprising a bottom wall, a top wall, a front wall, a back wall, a left side wall and a right side wall wherein the walls define an interior cargo chamber;
a temperature control unit (TCU) for controlling temperature within the cargo chamber; and
first, second and third temperature probes within the cargo chamber wherein one of the probes is mounted on the top wall.
